(19) United States
(12) Patent Application Publication
(10) Pub. No.: US 2010/0057532 A1
(43) Pub. Date: Mar. 4, 2010

(54) SYSTEM AND METHOD FOR DELIVERING RELEVANT BUSINESS INFORMATION TO CUSTOMER AND FOR TRACKING CUSTOMER RESPONSES

(76) Inventors: Thomas V. Sanguinetti, La Jolla, CA (US); Jeffrey S. Ploetner, La Jolla, CA (US); Dave T. Sanguinetti, La Jolla, CA (US)

Correspondence Address: Kirk William Hermann, Attorney, 510 North Villa Court, #103, Palm Springs, CA, 92262, US

(21) Appl. No.: 12/203,834

(22) Filed: Sep. 3, 2008

(51) Int. Cl. G06Q 30/00

(52) U.S. Cl. 705/10

(57) ABSTRACT

A method and system delivers relevant information about a business to a customer and tracks customer visits to the business premise responsive to the delivery of relevant information. The method includes receiving by a computer-implemented system one or more queries from the customer for the relevant information about one or more businesses. The method further includes presenting through the communication network a total set of businesses to the customer, the total set being a list of identified businesses to the customer. The customer views online a view set of the businesses, the view set being at least a subset of the identified businesses on the list. The method further includes tracking customer visit to the premises of the one or more identified businesses based on location data transmitted by a customer mobile device.

### TECHNICAL FIELD

The invention relates generally to information delivery services and, more particularly, the invention relates to a system and method for delivering relevant business information to customers and for tracking customer responses.

### BACKGROUND OF THE INVENTION

The growth of the Internet has enabled businesses such as department stores, furniture stores, restaurants, bars, manufacturers, automobile dealers, and other business establishments to advertise and deliver information to customers online. Today, a customer may search and retrieve information about the business online. However, existing online services often do not allow businesses to advertise in a cost effective and efficient manner. Existing services do not allow the businesses to specify a priori how many customers it would like to draw and how much the business is willing to pay for each customer drawn as a result of its advertisement. Instead, an advertiser is forced to pay for an ad placement without any guarantee of drawing the customer. For example, a restaurant owner or a retail business owner does not have accurate information about the actual cost of drawing customers via the ad placements.

Existing services allow advertisers to target customers by demographics or geographic locations, but do not allow the advertisers, i.e., businesses, to track customer responses accurately. One existing service allows the use of coupons or referral programs, which typically offers the customer a discount in exchange for presenting the coupon or referral information in order for the businesses to monitor the effectiveness of advertising. Thus, existing services provide limited a priori specification regarding customer acquisition cost. Traditional media and online services do not allow advertisers to specify a priori how much they are willing to pay for a new customer. Existing advertising methods are essentially blind advertising because accurate customer acquisition costs are usually unknown and also are difficult to estimate. Furthermore, the effectiveness of the existing advertising services cannot be assessed accurately even when coupons or referral programs are used. Tracking by coupons is inaccurate because coupons may not always be presented or collected properly. Coupons are also cumbersome for the customers to present and they add an overhead for tracking. Also, coupons may be undesirable for many high-end businesses because coupons may negatively affect the image of the business.

### SUMMARY

In one embodiment, a method and system delivers relevant information about a business to a customer and tracks customer visits to the business premise responsive to the delivery of relevant information. The method utilizes a computer-implemented system connected to a communication network for communication with the customer.

In one embodiment, the method includes receiving by the computer-implemented system one or more queries from the customer for the relevant information about one or more businesses. The method further includes receiving by the computer-implemented system customer preferences. The customer preferences include one or more customer-preferred attributes. The method further includes searching a database containing a plurality of business records of businesses, each record having one or more business attributes. The search is conducted based on the one or more queries from the customer. The method further includes comparing the business attributes of the businesses with the customer-preferred attributes and identifying one or more businesses from the database based on the comparison of the customer-preferred attributes and the business attributes. The method further includes presenting through the communication network a total set of businesses to the customer, the total set being a list of identified businesses to the customer. The customer views online a view set of the businesses, the view set being at least a subset of the identified businesses on the list. The method further includes tracking customer visit to the premises of the one or more identified businesses based on location data transmitted by a customer mobile device. The location data indicates the customer's physical presence on the premises.

The method further includes receiving from the business a customer bid. The customer bid being the amount the business is willing to pay for the customer visit to the business premise responsive to the delivery of the relevant information. The method further includes listing the one or more identified businesses based on the customer maximum bid, wherein the business is ranked on the list based on the customer maximum bid.

The method further includes searching the database containing a plurality of business records each having one or more business attributes. The method further includes identifying the business records having one or more similarity matches and presenting at least one or more of the identified business records. The similarity match may indicate a particular business attribute is similar to at least one customer-preferred attribute or may indicate a particular business attribute is equivalent to at least one customer-preferred attribute.

The method further includes determining the amount of time the customer spent viewing the one or more identified businesses on the list. The method further includes generating an invoice based on the amount of time the customer spent viewing the one or more identified businesses on the list, wherein a particular business is charged based on the amount of time spent viewing the particular business. The method further includes generating an invoice based on the customer visit to the business premise, wherein the business is charged based on the visit to the business premise or based on the amount of time the customer spent on the business premise.

### BRIEF DESCRIPTION OF THE DRAWINGS

FIG. 1 is a flow diagram of the steps for delivering relevant information about a business to a customer and for tracking customer visits to the business premise responsive to the relevant information.

FIG. 2 is a flow diagram of further steps for delivering relevant information about a business to a customer and for tracking customer visits to the business premise responsive to the relevant information.

FIG. 3 is a flow diagram of further steps for tracking customer response to the relevant information and for charging a business.

FIG. 4 is computer-implemented system for delivering relevant business information to a customer and for tracking customer responses.

### DETAILED DESCRIPTION OF THE INVENTION

In one example embodiment, a method and system delivers relevant information about a business to a customer and tracks customer visits to the business premise responsive to the delivery of relevant information. The business is charged for the customer visits to the business premise in response to the delivery of the relevant information. The business may also be charged responsive to the customer viewing the relevant information online. The method utilizes a computer-implemented system connected to a communication network for communication with the customer. The communication network may, for example, be the Internet.

In one aspect, the method and system provides advertising and tracking service to the businesses by delivering relevant information about the business to the customers, which increases the likelihood of the customers visiting the business premise or viewing the information online, and by tracking the customer visits to the business premises and also by tracking the amount of time the customer spent viewing the information online. The businesses may be restaurants, retail stores, grocery stores, furniture stores or any other business establishments.

In one example implementation, the system includes a search engine for searching a database of business records. Each business record includes a plurality of data fields representing business attributes or features. The system receives one or more queries from the customer for the relevant information about one or more businesses. The queries generally include customer preferences, including customer-preferred attributes. For example, a customer may request information about restaurants or department stores. A customer query may include customer-preferred attributes such as Italian restaurants in a specific zip code that offer certain specialties within a particular price range. A customer query may, for example, include customer-preferred attributes such as department stores in a specific zip code selling certain brand of clothing and certain brand of fragrances.

A customer query can contain a number of parameters, such as keyword search terms, time, location, and customer-preferred attributes. For example, suppose the customer specifies a keyword “pizza”. The system searches a database containing a plurality of business records to identify businesses matching the specified keyword within time and distance constraints, and returns a list of relevant results. In another example, suppose the customer specifies that she wishes to receive information about nearby restaurants. The system considers information such as the customer's (i.e., user) current location, time, and customer-preferred attributes. Suppose the customer's preferred attributes indicate that she enjoys Italian cuisine. The system may use this information to search a database containing a plurality of business records and return a list of relevant results containing nearby Italian restaurants that are currently open.

The system searches the database containing a plurality of business records based on the queries from the customer. The system compares the business attributes of the businesses with the customer-preferred attributes. The business attributes are the features of the businesses. For example, an Italian restaurant in the desired zip code may offer the preferred specialties, but may not offer the specialties within the desired price range. Thus, the Italian restaurant satisfies three customer-preferred attributes (i.e., Italian restaurant, zip code, specialties) but fails to satisfy one (i.e., desired price range). A department store, for example, in the desired zip code may offer the preferred brand of clothing but may not offer the preferred brand of fragrances. Thus, the department store satisfies three customer-preferred attributes (i.e., department store, zip code, clothing) but fails to satisfy one (i.e., fragrance).

In one implementation, the 10 most relevant businesses are computed by the system, based on a plurality of factors. The list of 10 most relevant businesses may then be sorted by a combination of descending customer max bid and relevance (which may include distance and customer-established metrics such as reviews, visits per view, and average distance traveled per visit). For example, a business that is geographically further away from a particular customer may need to have a higher customer max bid than businesses near the customer in order to rank competitively and therefore improve their chances of drawing the customer. Likewise, a less relevant business may need to have a higher customer max bid in order to rank competitively with more relevant businesses. One implementation may sort the list of 10 most relevant businesses by descending bid, and secondarily sort by relevance to resolve ties. In one implementation, the customer bid is determined by the system based on a plurality of customer maximum bids (e.g., plurality of customer maximum bids from other businesses), but the customer bid does not exceed the business' customer maximum bid.

The system identifies one or more businesses from the database based on the comparison of the customer-preferred attributes and the business attributes. The identified businesses, also referred to as a total set, are presented to the customer. The customer may view a view set, which is at least a subset of the total set. The system tracks the amount of time the customer spends viewing the businesses in the view set, and the business is charged based on the amount of time the customer spends viewing the view set. If the customer visits one or more identified businesses, the system tracks the customer visits from location information transmitted by the customer's mobile device. The mobile device may be a mobile phone, a global positioning device, a PDA or any other wireless device capable of transmitting or otherwise providing location data. The system tracks the customer visit to the business premise based on location data transmitted by a mobile device. In one implementation the business is charged based on the customer visit to the business visit. The business may be charged a flat fee based on the customer visit or may be charged based on the amount of time the customer spends on the business premise.

In one implementation, a Visit Classifier determines whether a customer has made a qualifying visit to a business based on a predetermined set of specific conditions to be met. The purpose of the Visit Classifier is to determine whether the customer visited the business as a direct result of the business being part of the customer's recent view set. For example, when businesses are added to the view set, the geo-coordinates of the customer's querying (mobile) device are recorded as initial geo-coordinates and are monitored by the system. The geo-coordinates of the customer's querying (e.g., mobile) device are monitored to detect if the customer approaches any of the businesses in the view set, within a pre-determined timeframe, such as 7 days. If the customer approaches a business within the current view set, the system monitors the duration for which the customer remains at the business location, and compares it to the minimum time requirement. The minimum time requirement may be specified as a factor of the average time spent at the business by customers (e.g. to meet minimum time requirement, customer visit must last no less than 2 standard deviations below the mean time spent by customers). Optional factors, such as the amount of information viewed about each business or time spent viewing each business in the view set, or the distance traveled from the initial geo-coordinates to the business location, are considered to improve backwards compatibility with less-precise location determination services, such as triangulation methods, to enhance classification accuracy. If the Visit Classifier determines a customer has made a qualifying visit to a business, the business is charged based on their bid, as calculated when the system returned the total set to the customer containing the business that was viewed and visited by the customer.

In one example embodiment, the system may be implemented in a computer system running an application to provide search capabilities, in the form of a search engine, to enable customers to search for relevant business information. The search engine may search a data store, e.g., a database, having a business directory listing information related to businesses to provide the relevant information to the customers.

In an illustrative implementation, the system may be deployed on an Internet web site that offers customers relevant business information. Also, the system may be deployed on an online social networking site having a plurality of users or members. By offering the system to the online social networking sites, the system enables users to conveniently search for restaurants, clubs, department stores, and other businesses based on preferred-attributes.

In an illustrative implementation, the system may comprise a user interface to enter queries including one or more customer-preferred or selected attributes or qualifiers and a data store that houses the business records and/or customer-preferred attributes data. The business records may list the information according to a predefined data classification. The user may access the system via the Internet using a computing device such as a personal computer, a lap-top computer, a smart phone or a wireless device. The system may comprise a means for displaying the search results. In operation, the search engine polls the data store according to a predefined set of rules and instructions for the relevant business information.

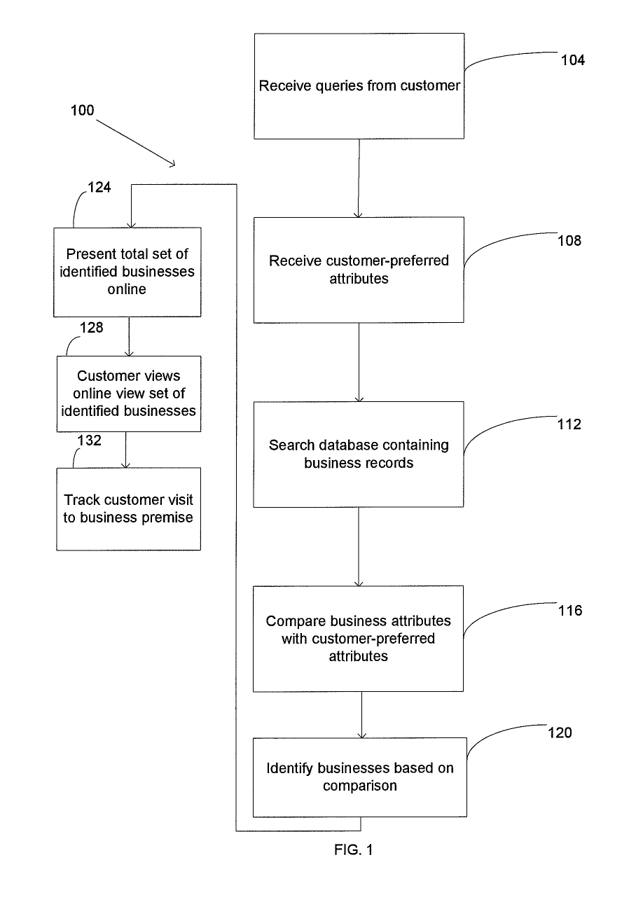

FIG. 1 is an example flow diagram of the steps for delivering relevant information about a business to a customer and for tracking customer visits to the business premise responsive to the relevant information. As discussed before, a computer-implemented system connected to a communication network is used to deliver the relevant information to the customer. In step 104, the system receives one or more queries from the customer for the relevant information about one or more businesses. For example, the customer may request information about Italian restaurants that feature certain regional specialties within a price range in the customer's geographical location or zip code. In step 108, the system receives customer preferences that include one or more customer-preferred attributes. The customer preferences including customer-preferred attributes may be stored in a database prior to the customer requesting relevant information. In one example implementation, the system maintains a customer profile in database, which contains one or more customer-preferred attributes.

In step 112, the system searches a database containing a plurality of business records of businesses. In one example implementation, each record contains one or more business attributes. The system conducts the search based on the one or more queries from the customer. In step 116, the system compares the business attributes of the businesses with the customer-preferred attributes. In step 120, the system identifies one or more businesses from the database based on the comparison of the customer-preferred attributes and the business attributes. In step 124, the system presents through the communication network a total set of businesses to the customer, the total set being a list of identified businesses to the customer. In step 128, the customer views a view set of the businesses online. The view set is at least a subset of the identified businesses on the list. As discussed before, the customer may decide to visit the business premise after reviewing the relevant information online. In step 132, the customer visit to the business premise is tracked based on location data transmitted by a customer mobile device. The location data indicates the customer's physical presence on the premises. The mobile device may be a wireless phone, a PDA, a GPS device or any other wireless device capable of transmitting location data.

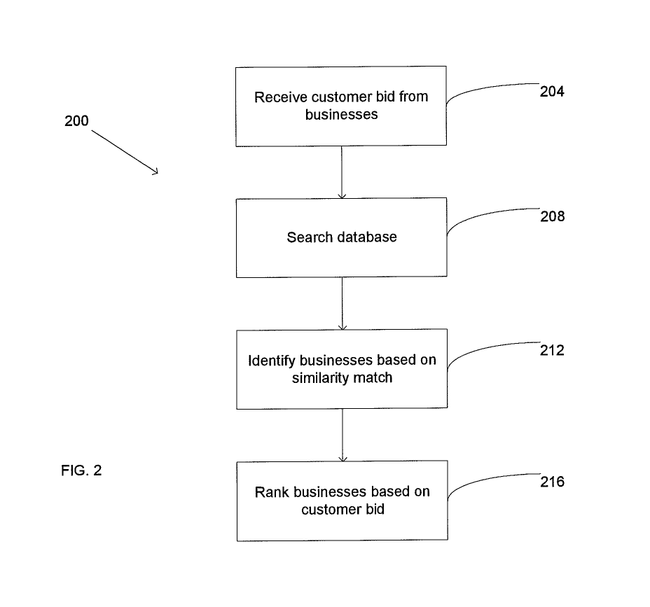

FIG. 2 is a flow diagram of further steps for delivering relevant information about a business to a customer and for tracking customer visits to the business premise responsive to the relevant information. In step 204, the system receives a customer bid from the business. The customer bid is the amount the business is willing to pay for the customer visit to the business premise responsive to the delivery of the relevant information. The customer bid may be a customer maximum bid, which is the maximum amount the business is willing to pay for the customer.

In step 208, the database containing a plurality of business records is searched. Each business record may have one or more business attributes. In step 212, the business records having similarity matches are identified. A similarity match may indicate that a particular business attribute is similar to at least one customer-preferred attribute or may indicate that a particular business attribute is equivalent to at least one customer-preferred attribute. In step 216, the identified business records are ranked based on the customer bid and are presented to the customer online. For example, a business offering a higher customer bid may be ranked higher on the list than a business offering a lower customer bid.

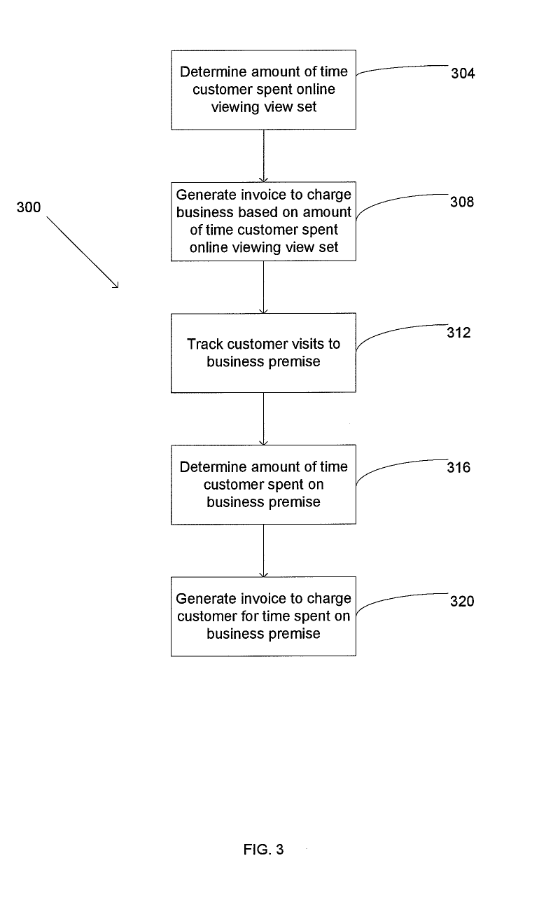

FIG. 3 is a flow diagram of the further steps for tracking customer response to the relevant information and charging the business. In step 304, the system determines the amount of time the customer spent online viewing the one or more identified businesses on the list. In step 308, the system generates an invoice based on the amount of time the customer spent online viewing the one or more identified, listed businesses. In one implementation, a particular business is charged based on the amount of time the customer spent viewing online the particular business. In one example implementation, an invoice is electronically generated and transmitted to the business for billing purposes.

In step 312, the system tracks the customer visit to the business premise in response to the delivery of the relevant information about the business or in response to the customer viewing the presented information online. As discussed before, location data transmitted by a mobile device, a cell phone, a GPS device or any other wireless device capable of transmitting location data enables the system to track the customer presence in the business premise. In step 316, the system calculates the amount of time the customer spent on the premise from the location data. In step 320, the business is charged based on the amount of time the customer spent on the business premise. In one implementation, an invoice is electronically generated and transmitted to the business for billing purposes.

In one implementation, the similarity match is determined by a similarity value. The business attributes of particular business records are compared to the customer-preferred attributes, and each business attribute is multiplied by a weight factor and a similarity factor. The weight factor indicates the importance of the particular attribute and the similarity factor indicates how similar the business attribute is to a customer-preferred attribute. In one example implementation, the similarity value may be represented by the following equation:

SV={(A₁×WF₁×SF₁)+(A₂×WF₂×SF₂)+(A₃×WF₃×SF₃)+ . . . +(A_{N}×WF_{N}×SF_{N})}

In the above equation, A₁-A_{N} are the business attributes, WF₁-WF_{N} are the weight factors, and SF₁-SF_{N} are the similarity factors. It will be appreciated that various other methods and formulae may be used to calculate the similarity value.

In one implementation, the similarity value of a plurality of business records in the database is calculated, and the business records are listed based on the similarity values. In one implementation, business records having a similarity value higher than a threshold value are listed and presented to the customer online. In one implementation, qualified business records (i.e., business records having a similarity value higher than a threshold value) are ranked based on their customer bid. Various other methods and formulae may be used to identify qualified business records.

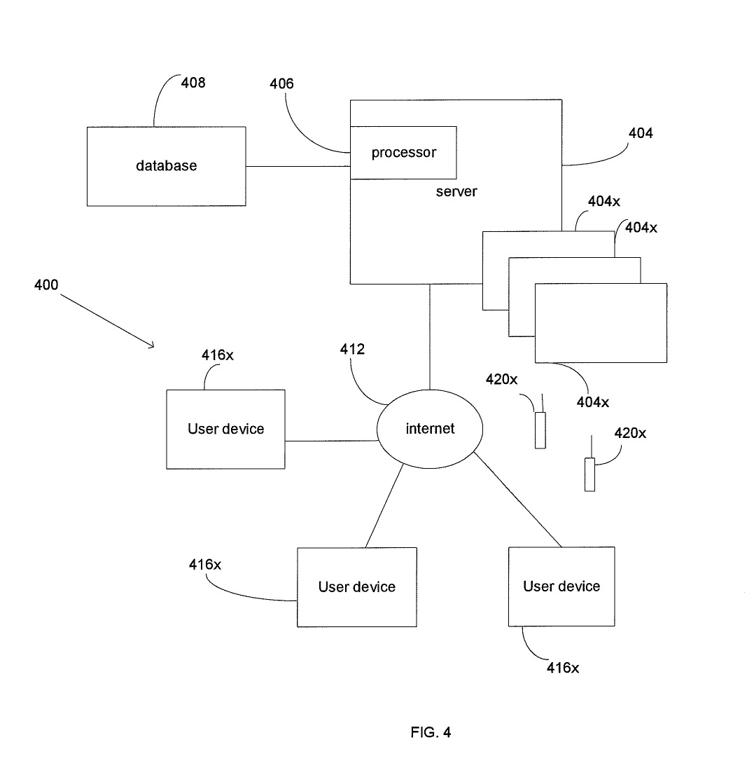

FIG. 4 is a computer-implemented system 400 for delivering relevant business information to a customer and for tracking customer responses. As discussed before, responsive to the delivery of the relevant information, the customer may spend time online reviewing the information or may visit the business premise. The system 400 tracks the amount of time the customer views the relevant information online and also tracks the customer visit to the business premise and the amount of time spent on the premise.

The system 400 may be deployed on an Internet web site that offers the relevant business information to customers and other users. Also, the system 400 may be deployed on an online social networking site having a plurality of users.

The system 400 includes a server 404 having a processor 406. The server 404 is connected to a data store such as a database 408. The database 408 includes a plurality of business records each having one or more business attributes. The database 408 may also store the customer-preferred attributes. The customer-preferred attributes may be stored a priori or may be received concurrently with the customer query for the relevant information.

Responsive to one or more customer or user queries, the processor 406 polls the business records in the database 408 for one or more businesses and provides a result having one or more identified or listed businesses. The server 404 is connected to a plurality of user devices 416x via the Internet 412. The user device 416x may be a personal computer, a lap-top computer, a PDA, a wireless device, a smart phone or any other computing device. A user may use the user device 416x to connect with the server 404 via the Internet. The server 404 is configured to serve one or more web pages 404x to the user devices 416x. The user devices 416x use the web pages 404x to input search queries having one or more attributes and other information. The system 400 also provides the search result on one or more web pages 404x.

Responsive to the delivery of one or more identified or listed businesses (i.e., relevant business information), the user may spend an amount of time viewing the information online. For example, the user may view a subset, referred to as a view set, of the information presented online. The server 404 tracks the amount of time the user spends viewing the view set online. The processor 406 may generate an invoice charging the business based on the time the user spent online viewing the view set.

The server 404 is connected to a plurality of customer wireless devices 420x. As will be appreciated, the wireless devices 420x and the user devices 416x may be same or different devices. Responsive to the delivery of the relevant information, the customer may visit the business premise. The server 404 tracks the customer visits to the business premises from the location data transmitted by the customer wireless devices. The system 400 charges the business based on the amount of time the customer spent on the business premise. The system 400 may electronically generate and transmit an invoice to the business detailing charges based on the customer visits to the business premise responsive to the delivery of the relevant information.

In one example embodiment, a computer program product having a computer readable medium embodies a plurality of computer readable codes for executing the method steps described above.

The system, method, computer program product may, of course, be embodied in hardware; e.g., within or coupled to a Central Processing Unit (“CPU”), microprocessor, microcontroller, System on Chip (“SOC”), or any other programmable device. Additionally, the system, method, computer program product, and propagated signal may be embodied in software (e.g., computer readable code, program code, instructions and/or data disposed in any form, such as source, object or machine language) disposed, for example, in a computer usable (e.g., readable) medium configured to store the software. Such software enables the function, fabrication, modeling, simulation, description and/or testing of the apparatus and processes described herein. For example, this can be accomplished through the use of general programming languages (e.g., C, C++), GDSII databases, hardware description languages (HDL) including Verilog HDL, VHDL, AHDL (Altera HDL) and so on, or other available programs, databases, nanoprocessing, and/or circuit (i.e., schematic) capture tools. Such software can be disposed in any known computer usable medium including semiconductor, magnetic disk, optical disc (e.g., CD-ROM, DVD-ROM, etc.) and as a computer data signal embodied in a computer usable (e.g., readable) transmission medium (e.g., carrier wave or any other medium including digital, optical, or analog-based medium). As such, the software can be transmitted over communication networks including the Internet and intranets. A system, method, computer program product, and propagated signal embodied in software may be included in a semiconductor intellectual property core (e.g., embodied in HDL) and transformed to hardware in the production of integrated circuits. Additionally, a system, method, computer program product, and propagated signal as described herein may be embodied as a combination of hardware and software.

One of the implementations of the present invention is as a routine in an operating system made up of programming steps or instructions resident in a memory of a computing system as well known, during computer operations. Until required by the computer system, the program instructions may be stored in another readable medium, e.g., in a disk drive, or in a removable memory, such as an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Internet, when required by the user of the present invention. One skilled in the art should appreciate that the processes controlling the present invention are capable of being distributed in the form of computer readable media in a variety of forms.

Any suitable programming language can be used to implement the routines of the present invention including C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments. In some embodiments, multiple steps shown as sequential in this specification can be performed at the same time. The sequence of operations described herein can be interrupted, suspended, or otherwise controlled by another process, such as an operating system, kernel, and the like. The routines can operate in an operating system environment or as stand-alone routines occupying all, or a substantial part, of the system processing.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a general purpose digital computer, software applications, routines and software modules, hardware including application specific integrated circuits, programmable logic devices, field programmable gate arrays, optical and other mechanisms may be used. In general, the functions of the present invention can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

From the foregoing it will be appreciated that, although specific embodiments of the invention have been described herein for purposes of illustration, various modifications may be made without deviating from the spirit and scope of the invention. Accordingly, the invention is not limited except as by the appended claims.

What is claimed is:

1. A method for delivery of relevant information about a business to a customer and for tracking customer visit to the business premise responsive to the delivery of relevant information, the method utilizing a computer-implemented system connected to a communication network for communication with the customer, comprising:
receiving by the computer-implemented system one or more queries from the customer for the relevant information about one or more businesses;
receiving by the computer-implemented system customer preferences, the customer preferences including one or more customer-preferred attributes;
searching a database containing a plurality of business records of businesses, each record having one or more business attributes, the search conducted based on the one or more queries from the customer;
comparing the business attributes of the businesses with the customer-preferred attributes;
identifying one or more businesses from the database based on the comparison of the customer-preferred attributes and the business attributes;
presenting through the communication network a total set of businesses to the customer, the total set being a list of identified businesses to the customer;
viewing online, by the customer, a view set of the businesses, the view set being at least a subset of the identified businesses on the list; and
tracking customer visit to the premises of the one or more identified businesses based on location data transmitted by a customer mobile device, the location data indicating the customer's physical presence on the premises.

2. The method according to claim 1, further comprising:
receiving from the business a customer maximum bid, the customer maximum bid being the maximum amount the business is willing to pay for the customer visit to the business premise responsive to the delivery of the relevant information; and
listing the one or more identified businesses based on the customer maximum bid, wherein the business is ranked on the list based on the customer maximum bid.

3. The method according to claim 1, further comprising:
receiving from the business a customer bid, the customer bid being the amount the business is willing to pay for the customer visit to the business premise responsive to the delivery of the relevant information; and
listing the one or more identified businesses based on the customer bid, wherein the business is ranked on the list based on the customer bid.

4. The method according to claim 1, further comprising:
searching the database containing a plurality of business records each having one or more business attributes;
identifying the business records having one or more similarity matches; and
presenting at least one or more of the identified business records.

5. The method according to claim 4, wherein the similarity match indicates a particular business attribute being similar to at least one customer-preferred attribute.

6. The method according to claim 4, wherein the similarity match indicates a particular business attribute being equivalent to at least one customer-preferred attribute.

7. The method according to claim 1, further comprising:
determining the amount of time the customer spent viewing the one or more identified businesses on the list; and
generating an invoice based on the amount of time the customer spent viewing the one or more identified businesses on the list, wherein a particular business is charged based on the amount of time spent viewing the particular business.

8. The method according to claim 1, further comprising generating an invoice based on the customer visit to the business premise, wherein the business is charged based on the visit to the business premise.

9. The method of claim 1, further comprising:
determining the amount of time the customer spent on the premise from the location data; and
charging the business based on the amount of time the customer spent on the business premise.

10. A method for tracking customer visits to a business premise responsive to a delivery of relevant information and for charging the business for the customer visit, the method utilizing a computer-implemented system connected to a communication network for communication with the customer, comprising:
receiving by the computer-implemented system one or more queries from the customer;
receiving by the computer-implemented system customer preferences, the customer for the relevant information about one or more businesses; preferences including one or more customer-preferred attributes;
searching a database containing a plurality of business records of the businesses, each record having one or more business attributes, the search conducted based on the one or more queries;
comparing the business attributes of the businesses with the customer-preferred attributes;
identifying one or more businesses from the database based on the comparison of the customer-preferred attributes and the business attributes;
presenting through the communication network a total set of the businesses to the customer, the total set of the businesses being a list of the identified businesses;
viewing online by the customer a view set of the total set; the view set being at least a subset of the identified businesses on the list;
tracking customer visit to the premises of the identified businesses based on location data transmitted by a customer mobile device, the location data indicating customer's physical presence in the premises; and
generating an invoice for the business based on the customer visit, wherein the business is charged a predetermined amount based on the customer visit to the premises.

11. The method according to claim 10, wherein the invoice is generated and transmitted to the business electronically.

12. The method according to claim 10, further comprising:
receiving from the business a customer bid, the customer bid being the amount the business is willing to pay for the customer visit to the business premise responsive to the delivery of the relevant information; and
listing the one or more identified businesses based on the customer bid, wherein the business is ranked on the list based on the customer bid.

13. The method according to claim 10, further comprising:
searching the database containing a plurality of business records each having one or more business attributes;
identifying the business records having one or more similarity matches;
presenting at least one or more of the identified business records.

14. The method according to claim 13, wherein the similarity match indicates a particular business attribute being similar to at least one customer-preferred attribute.

15. A method for tracking customer visits to a business premise responsive to a delivery of relevant information regarding the business, the method utilizing a computer-implemented system connected to a communication network for communication with the customer, comprising:
searching a database containing a plurality of business records of businesses, each record having one or more business attributes;
comparing the business attributes of the businesses with one or more customer-preferred attributes;
identifying one or more businesses from the database based on the comparison of the customer-preferred attributes and the business attributes;
presenting through the communication network a list of identified businesses to the customer;
viewing, by the customer, at least a subset of the identified businesses on the list;
tracking customer visit to the premises of the one or more identified businesses based on location data transmitted by a customer mobile device, the location data indicating the customer's physical presence on the premises;
generating an invoice to charge the business for the customer visit; and
electronically transmitting the invoice to the business.

16. The method according to claim 15, further comprising:
receiving from the business a customer bid, the customer bid being the amount the business is willing to pay for the customer visit to the business premise responsive to the delivery of the relevant information; and
listing the one or more identified businesses based on the customer bid, wherein the business is ranked on the list based on the customer bid.

17. The method according to claim 15, further comprising:
generating an invoice based on the amount of time the customer spent viewing the identified business online; and
transmitting the invoice to the business.

18. A computer-implemented system for delivery of relevant information about a business to a customer and for tracking customer visit to the business premise responsive to the delivery of relevant information, the computer-implemented system being connected to a communication network for communication with the customer, comprising:
a server having a processor connected to the communication network and configured to serve one or more web pages to the customer, the processor configured to receive a plurality of user inputs;
a database connected to the processor, the database containing a plurality of business records each having one or more business attributes, the database responsive to the processor to provide data to the processor, the processor configured to execute a plurality of steps comprising:
receiving one or more queries from the customer for the relevant information about one or more businesses;
receiving customer preferences including one or more customer-preferred attributes;
searching the database containing the plurality of business records, the search conducted based on the one or more queries from the customer;
comparing the business attributes of the businesses with the customer-preferred attributes;
identifying one or more businesses from the database based on the comparison of the customer-preferred attributes and the business attributes;
presenting through the communication network a total set of businesses to the customer, the total set being a list of identified businesses to the customer;
viewing online, by the customer, a view set of the businesses, the view set being at least a subset of the identified businesses on the list; and
tracking customer visit to the premises of the one or more identified businesses based on location data transmitted by a customer mobile device, the location data indicating the customer's physical presence on the premises.

19. The computer-implemented system of claim 18, wherein the steps executed by the processor further comprises:
receiving from the business a customer bid, the customer bid being the amount the business is willing to pay for the customer visit to the business premise responsive to the delivery of the relevant information; and
listing the one or more identified businesses based on the customer bid, wherein the business is ranked on the list based on the customer bid.

20. The computer-implemented system of claim 18, wherein the steps executed by the processor further comprises:
searching the database containing a plurality of business records each having one or more business attributes;
identifying the business records having one or more similarity matches; and
presenting at least one or more of the identified business records.

21. The computer-implemented system of claim 18, wherein the similarity match indicates a particular business attribute being similar to at least one customer-preferred attribute.

22. The computer-implemented system of claim 18, wherein the similarity match indicates a particular business attribute being equivalent to at least one customer-preferred attribute.

23. The computer-implemented system of claim 18, wherein the steps executed by the processor further comprises:
determining the amount of time the customer spent viewing the one or more identified businesses on the list; and
generating an invoice based on the amount of time the customer spent viewing the one or more identified businesses on the list, wherein a particular business is charged based on the amount of time spent viewing the particular business.

24. The computer-implemented system of claim 18, wherein the steps executed by the processor further comprises generating an invoice based on the customer visit to the business premise, wherein the business is charged based on the visit to the business premise.

25. The computer-implemented system of claim 18, wherein the steps executed by the processor further comprises:
determining the amount of time the customer spent on the premise from the location data; and
charging the business based on the amount of time the customer spent on the business premise.
